(19) United States
(12) Patent Application Publication
(10) Pub. No.: US 2008/0042956 A1
(43) Pub. Date: Feb. 21, 2008

(54) DISPLAY PANEL AND METHOD THEREOF

(75) Inventors: Seung-Hyun Hur, Cheonan-si (KR); Kweon-Sam Hong, Seoul (KR); Sang-Gun Choi, Suwon-si (KR); Yong-Woo Lee, Seoul (KR); Hyun-Duck Son, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/839,822

(22) Filed: Aug. 16, 2007

(30) Foreign Application Priority Data
Aug. 16, 2006 (KR) 10-2006-0077252

(51) Int. Cl. G09G 3/36

(52) U.S. Cl. 345/92; 345/87

(57) ABSTRACT

In a display panel, gate lines, data lines, pixel electrodes and a trap electrode are formed on a second display substrate. The gate lines are extended in a first direction, and the data lines are extended in a second direction while insulating from and intersecting with the gate lines. The pixel electrodes may have a W shape rotated in a counter-clockwise direction. The trap electrode is formed in a black matrix area among the pixel electrodes and a different voltage (e.g. a gate-off voltage) from the pixel voltage applied to the pixel electrodes is applied to the trap electrode. Thus, ion impurities in the display panel are trapped into the black matrix area, thereby removing an image sticking caused by the ion impurities.

This application claims priority to Korean Patent Application No. 2006-77252, filed on Aug. 16, 2006, and all the benefits accruing therefrom under 35 U.S.C. §119, and the contents of which in its entirety are herein incorporated by reference.

### BACKGROUND OF THE INVENTION

1. Field of the Invention

The present invention relates to a display panel and a method thereof. More particularly, the present invention relates to a display panel capable of improving display quality thereof, and a method of improving display quality of the display panel.

2. Description of the Related Art

In general, a liquid crystal display (“LCD”) includes an array substrate, a color filter substrate facing the array substrate, and a liquid crystal layer interposed between the array substrate and the color filter substrate.

The array substrate includes a plurality of pixels that displays an image. Each of the pixels has a gate line, a data line, a thin film transistor (“TFT”), and a pixel electrode. The gate line and the data line receive a gate signal and a data signal, respectively, and are electrically connected to a gate electrode and a source electrode of the TFT, respectively. The pixel electrode is electrically connected to a drain electrode of the TFT and faces a common electrode formed on the color filter substrate while interposing the liquid crystal layer therebetween.

In comparison with a cathode ray tube (“CRT”) display device, the LCD has a disadvantage of a narrow viewing angle while having an advantage of a thin thickness.

In order to improve such a narrow viewing angle of the LCD, recently, a patterned vertical alignment (“PVA”) mode, a multi-domain vertical alignment (“MVA”) mode and a super patterned vertical alignment (“SPVA”) mode for the LCD have been researched and developed to realize wide viewing angle characteristics.

Meanwhile, when the LCD is driven for a long period of time, line or surface image sticking occurs on a display screen due to movement or accumulation of ion impurities. In general, the line image sticking occurs since ion components of liquid crystal are accumulated at a boundary between patterns that are driven in different gray scales with each other, and the surface image sticking occurs since residual DC components caused by ion impurities or a flickering phenomenon cause a brightness difference in a surface shape.

### BRIEF SUMMARY OF THE INVENTION

In view of the increased demand for technologies to improve a display quality of the liquid crystal display (“LCD”) when driving the LCD for a long period of time, the present invention provides exemplary embodiments for removing image sticking, such as in a wide viewing angle mode LCD.

Thus, the present invention provides a display panel capable of improving a display quality.

The present invention also provides a method of improving display quality of the display panel.

In exemplary embodiments of the present invention, a display panel includes a first display substrate having a first base substrate and a common electrode formed on the first base substrate to receive a common voltage, a second display substrate combined with the first display substrate while facing the first display substrate, and a liquid crystal layer disposed between the first and second display substrates.

The second display substrate includes a second base substrate facing the first base substrate, a plurality of gate lines, a plurality of data lines, a plurality of pixel electrodes, and a trap electrode.

The gate lines are arranged on the second base substrate and extended in a first direction. The data lines are extended in a second direction, and are insulated from and intersect with the gate lines. Each of the pixel electrodes is inclined at a predetermined angle with respect to the data lines and may have a W shape rotated in a counter-clockwise direction. The trap electrode is formed in a black matrix area among the pixel electrodes and receives a different voltage (e.g. a gate-off voltage) from a pixel voltage applied to the pixel electrodes to trap ion impurities.

According to the above, the trap electrode is formed among the pixel electrodes and the gate-off voltage is applied to the trap electrode, so that ion impurities may be trapped into the black matrix area, thereby removing an image sticking caused by the ion impurities.

In other exemplary embodiments of the present invention, a method of improving display quality of a display panel includes trapping ion impurities in the display panel into a black matrix area of the display panel to prevent an image sticking in the display panel, wherein trapping ion impurities includes applying a direct current field between a trap electrode formed in the black matrix area and pixel electrodes, and between the trap electrode and a common electrode.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a plan view showing an exemplary embodiment of an SPVA mode display panel according to the present invention;

FIG. 2 is a sectional view taken along line I-I′ shown in FIG. 1;

FIGS. 3A to 3C are plan views showing an exemplary manufacturing process of an exemplary second display substrate shown in FIG. 1;

FIG. 4 is a plan view showing an exemplary embodiment of a PVA mode display panel according to the present invention; and

FIG. 5 is a sectional view taken along line II-II′ shown in FIG. 4.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

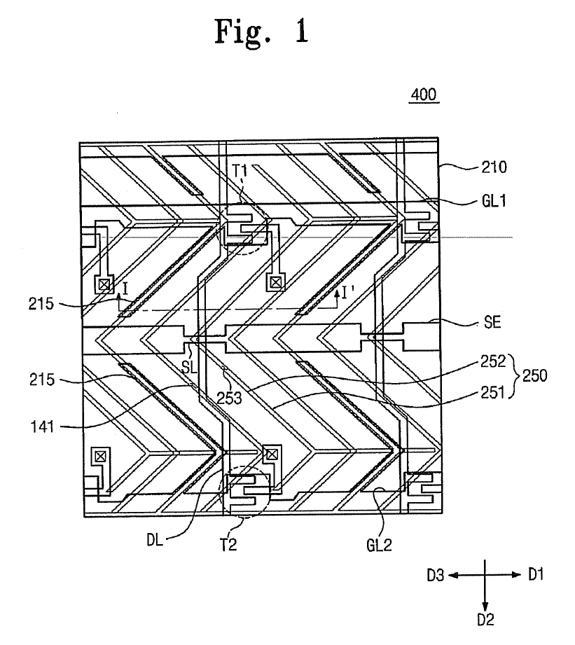

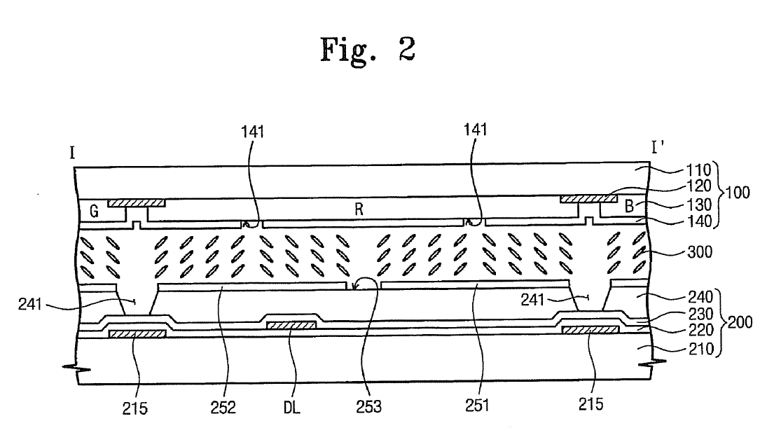

FIG. 1 is a plan view showing an exemplary embodiment of a super patterned vertical alignment (“SPVA”) mode display panel according to the present invention, and FIG. 2 is a sectional view taken along line I-I′ shown in FIG. 1.

Referring to FIGS. 1 and 2, an SPVA mode display panel 400 includes a first display substrate 100, a second display substrate 200 combined with the first display substrate 100 while facing the first display substrate 100, and a liquid crystal layer 300 interposed between the first display substrate 100 and the second display substrate 200.

The first display substrate 100 includes a first base substrate 110, a black matrix 120, a color filter layer 130, and a common electrode 140. The color filter layer 130 having red R, green G and blue B color filters is arranged on the first base substrate 110, and the R, G and B color filters are formed in a one-to-one correspondence relationship with pixels. The black matrix 120 is interposed between the R, G and B color filters to prevent a light leakage between pixels.

The common electrode 140 is formed on the black matrix 120 and the color filter layer 130 with a uniform thickness. In an exemplary embodiment, the common electrode 140 includes indium tin oxide (“ITO”) or indium zinc oxide (“IZO”). The common electrode 140 is provided with a plurality of first openings 141 formed therethrough to expose the color filter layer 130.

Meanwhile, the second display substrate 200 includes a second base substrate 210 combined with the first base substrate 110 while facing the first base substrate 110 and a plurality of pixels arranged on the second base substrate 210 in a matrix configuration. Each of the pixels includes a main gate line GL1, a sub gate line GL2, a data line DL, a first thin film transistor (“TFT”) T1, a second TFT T2, a pixel electrode 250, a trap electrode 215, a storage line SL and a storage electrode SE.

The main and sub gate lines GL1 and GL2 are extended in a first direction D1 and spaced apart from each other by a set distance. A first gate signal is applied to the main gate line GL1 during an earlier H/2 period within a 1H period during which pixels connected to one row are operated, and the second gate signal is applied to the sub gate line GL2 during a later H/2 period within the 1H period. The first gate signal maintains a gate-on voltage and a gate-off voltage during the earlier H/2 period and the later H/2 period, respectively, and the second gate signal maintains the gate-off voltage and the gate-on voltage during the earlier H/2 period and the later H/2 period, respectively.

The data line DL is extended in a second direction D2 that is substantially perpendicular to the first direction D1 and is arranged on a different layer within the second display substrate 200 from a layer on which the main and sub gate lines GL1 and GL2 are formed and is insulated from and intersects with the main and sub gate lines GL1 and GL2. A high pixel voltage is applied to the data line DL during the earlier H/2 period and a low pixel voltage that is lower than the high pixel voltage is applied to the data line DL during the later H/2 period.

The pixel electrode 250 is divided into a main pixel electrode 251 and a sub pixel electrode 252. As will be further described below, the main pixel electrode 251 is connected to the first TFT T1, and the sub pixel electrode 252 is connected to the second TFT T2. Thus, the high pixel voltage is applied during the earlier H/2 period to the main pixel electrode 251 and the low pixel voltage is applied during the later H/2 period to the sub pixel electrode 252.

The first TFT T1 is electrically connected to the main gate line GL1 and the data line DL. Particularly, the first TFT T1 includes a first gate electrode connected to the main gate line GL1, a first source electrode connected to the data line DL and a first drain electrode connected to the main pixel electrode 251. Thus, the first TFT T1 applies the high pixel voltage to the main pixel electrode 251 in response to the first gate signal during the earlier H/2 period.

The second TFT T2 is electrically connected to the sub gate line GL2 and the data line DL. Particularly, the second TFT T2 includes a second gate electrode connected to the sub gate line GL2, a second source electrode connected to the data line DL and a second drain electrode connected to the sub pixel electrode 252. Thus, the second TFT T2 applies the low pixel voltage to the sub pixel electrode 252 in response to the second gate signal during the later H/2 period.

The pixel electrode 250 may have a W shape rotated in a counter-clockwise direction. That is, the pixel electrode 250 has the W shape when viewed at the first direction D1 toward a third direction D3 opposite to the first direction D1. The pixel electrode 250 is extended in the second direction D2 and partially removed along a longitudinal side of the pixel electrode 250, so that a second opening 253 is formed through the pixel electrode 250. Particularly, the second opening 253 is placed at a center of two longitudinal sides of the pixel electrode 250, which is parallel to each other. As shown in FIG. 2, the second opening 253 is placed at a location of the pixel electrode 250 that corresponds to a location between the first openings 141 formed through the common electrode 140. Thus, a plurality of domains in which liquid crystal molecules within the liquid crystal layer 300 between the pixel electrode 250 and the common electrode 140 are aligned in different directions is defined in one pixel.

The main pixel electrode 251 is electrically insulated from the sub pixel electrode 252 by the second opening 253. The main pixel electrode 251 may have a V shape rotated in a clockwise direction. The shape of the sub pixel electrode 252 is defined by subtracting the shape of the main pixel electrode 251 from the shape of the pixel electrode 250. The sub pixel electrode 252 is electrically insulated from the main pixel electrode 251 by the second opening 253. In the exemplary embodiment, the main pixel electrode 251 has an area size that is smaller than that of the sub pixel electrode 252.

The trap electrode 215 is branched from the main and sub gate lines GL1 and GL2 and arranged between the pixel electrode 250 and an adjacent pixel electrode in a row direction.

As shown in FIG. 2, a first portion of the trap electrode 215 is branched from the main gate line GL1 and a second portion of the trap electrode 215 is branched from the sub gate line GL2, and the trap electrode 215 is arranged on the second base substrate 210 such that the trap electrode 215 corresponds to a location between the pixel electrode 250 and the adjacent pixel electrode in the row direction. Particularly, the black matrix 120 of the first display substrate 100 is arranged in a one-to-one correspondence relationship with an area between the pixel electrode 250 and the adjacent pixel electrode, thereby preventing leakage of light through between the pixel electrode 250 and the adjacent pixel electrode. In the exemplary embodiment, the trap electrode 215 is arranged directly beneath the black matrix 120 in a black matrix area (hereinafter, referred to as “BM area”).

Since the trap electrode 215 is branched from the main and sub gate lines GL1 and GL2, the trap electrode 215 is maintained at the gate-off voltage during most of the time within one frame period. In an exemplary embodiment, the gate-off voltage may be about −6V, a pixel voltage applied to the pixel electrode 250 may be in a range of about 0V to about 10V, and a common voltage applied to the common electrode 140 may be about 5V.

Due to such a voltage difference, a direct current field is applied between the trap electrode 215 and the pixel electrode 250 and between the trap electrode 215 and the common electrode 140. Since ion impurities generated in the SPVA mode display panel 400 are trapped into the BM area due to the direct current field, an image sticking defect caused by the ion impurities may be removed, so that a display quality of the SPVA mode display panel 400 may be improved.

As shown in FIGS. 1 and 2, an area where the data line DL is formed does not match with the BM area. That is, the data line DL has a stripe shape extended generally in the second direction D2, however, the pixel electrode 250 has the W shape rotated in the counter-clockwise direction.

Thus, the black matrix 120 arranged on the first display substrate 100 has a W shape formed along the longitudinal side of the pixel electrode 250, and the data line DL on the second display substrate 200 is not formed in the BM area. Since the trap electrode 215 is formed in the BM area, the direct current field may be applied between the trap electrode 215 and the pixel electrode 250 and between the trap electrode 215 and the common electrode 140.

The storage line SL is extended in the first direction D1 and disposed between the main gate line GL1 and the sub gate line GL2. The storage electrode SE is extended in the first direction D1 and integrally formed with the storage line SL to have a substantially rectangular shape protruding from the storage line SL. The storage line SL receives the common voltage from an exterior to apply the common voltage to the storage electrode SE. The storage electrode SE faces the pixel electrode 250 while insulating layers, such as a gate insulating layer 220, a protective layer 230, and an organic insulating layer 240, are interposed between the storage electrode SE and the pixel electrode 250. The organic insulating layer 240 provides an opening 241 corresponding to the trap electrode 215.

The storage electrode SE and the storage line SL are formed from the same layer as the main and sub gate lines GL1 and GL2, however, the storage electrode SE and the storage line SL are spaced from and electrically insulated from the main and sub gate lines GL1 and GL2 since the storage electrode SE and the storage line SL receive different signals from those applied to the main and sub gate lines GL1 and GL2. Particularly, the trap electrode 215 that is branched from the main and sub gate lines GL1 and GL2 is spaced apart from the storage electrode SE by a particular distance, so that the trap electrode 215 is electrically insulated from the storage electrode SE.

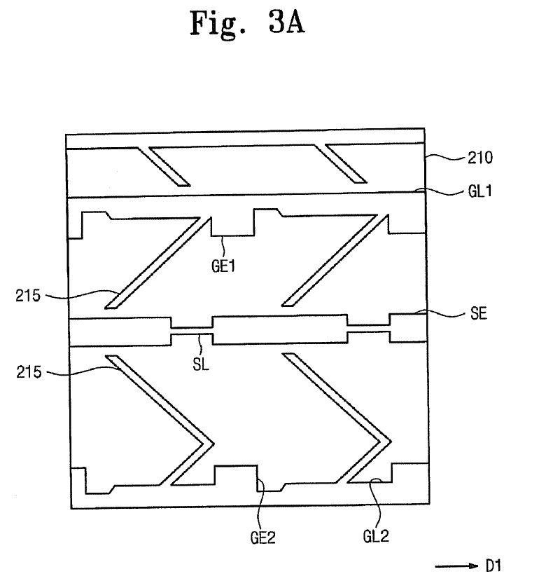

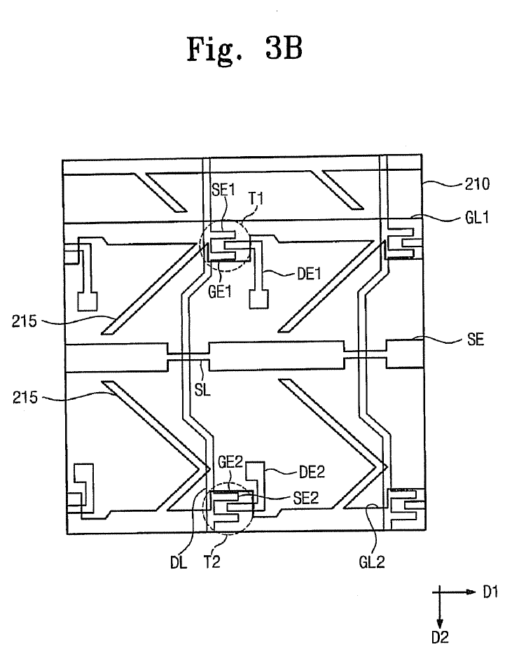

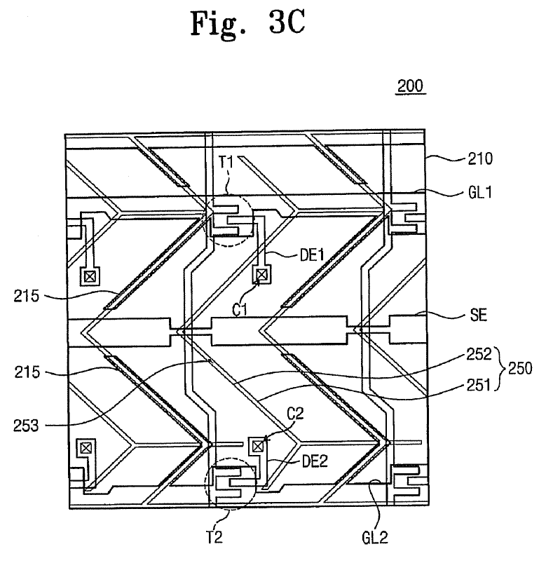

FIGS. 3A to 3C are plan views showing an exemplary manufacturing process of the exemplary second display substrate shown in FIG. 1.

Referring to FIG. 3A, a gate metal is formed on the second base substrate 210, and the gate metal is patterned to form the main gate line GL1, the sub gate line GL2, the first gate electrode GE1, the second gate electrode GE2, the storage line SL, the storage electrode SE, and the trap electrode 215.

The main and sub gate lines GL1 and GL2 are extended in the first direction D1, and the first gate electrode GE1 is branched from the main gate line GL1 and the second gate electrode GE2 is branched from the sub gate line GL2. The first and second gate electrodes GE1 and GE2 may protrude towards the storage line SL. The storage line SL is extended in the first direction D1 and arranged between the main gate line GL1 and the sub gate line GL2. The storage electrode SE is extended from the storage line SL, such as by protruding from the storage line SL towards the adjacent main and sub gate lines GL1, GL2. The trap electrode 215 is branched from the main gate line GL1 and the sub gate line GL2 and extended in a direction inclined at a predetermined angle with respect to the main and sub gate lines GL1 and GL2. That is, a first portion of the trap electrode 215 protrudes from and extends angularly with respect to the main gate line GL1, and a second portion of the trap electrode 215 protrudes from and extends angularly with respect to the sub gate line GL2. The angles of the trap electrode 215 with respect to the main and sub gate lines GL1 and GL2 corresponds to edges of the pixel electrode 250, as will be further described below. Free ends of the first and second portions of the trap electrode 215 are separated by the storage electrode SE. Also, the trap electrode 215 is spaced apart from the storage electrode SE and electrically insulated from the storage electrode SE.

With reference to FIG. 2, the main gate line GL1, the sub gate line GL2, the storage line SL, the storage electrode SE, and the trap electrode 215 formed on the second base substrate 210, as well as exposed portions of the second base substrate 210, are covered by a gate insulating layer 220.

Referring to FIG. 3B, a data metal is formed on the gate insulating layer 220 and patterned to form the data line DL, the first source electrode SE1, the second source electrode SE2, the first drain electrode DE1 and the second drain electrode DE2 on the gate insulating layer 220.

The data line DL is extended mainly in the second direction D2 that is substantially perpendicular to the first direction D1. The data line DL may be indented in the vicinity of the storage line SL such that it does not cross over the storage electrode SE. The first and second source electrodes SE1 and SE2 are branched from the data line DL, such as in an area overlapping the first and second gate electrodes GE1 and GE2, and the first and second drain electrodes DE1 and DE2 are spaced apart from the first and second source electrodes SE1 and SE2 with a predetermined distance, respectively.

Thus, the first TFT T1 that is electrically connected to the main gate line GL1 and the data line DL and the second TFT T2 that is electrically connected to the sub gate line GL2 and the data line DL are completed on the second base substrate 210. Although not shown, the first and second TFTs T1 and T2 may further include a semiconductor layer formed between the first gate electrode GE1 and the first source and drain electrodes SE1, DE1, and between the second gate electrode GE2 and the second source and drain electrodes SE2, DE2, respectively.

As shown in FIG. 2, the data line DL, as well as the first and second source electrodes SE1 and SE2, and the first and second drain electrodes DE1 and DE2, are covered by a protective layer 230 and an organic insulating layer 240 sequentially formed on the second base substrate 210. A first contact hole C1 and a second contact hole C2, shown in FIG. 3C, through which the first and second drain electrodes DE1 and DE2 are exposed, respectively, are formed through the protective layer 230 and the organic insulating layer 240.

With further reference to FIG. 3C, a transparent conductive layer including, for example, ITO or IZO is formed on the organic insulating layer 240. Then, the conductive layer is patterned to form a plurality of pixel electrodes 250, and the second opening 253 is formed to divide each pixel electrode 250 into the main pixel electrode 251 and the sub pixel electrode 252. As shown in FIG. 1, the second opening 253 is formed at a different place from the first opening 141 formed through the common electrode 140. That is, the second opening 253 is not overlapped by the first opening 141, but is offset from a location of the first opening 141.

The main pixel electrode 251 is electrically connected to the first drain electrode DE1 through the first contact hole C1, and the sub pixel electrode 252 is electrically connected to the second drain electrode DE2 through the second contact hole C2. Thus, the second display substrate 200 having the trap electrode 215 is completed.

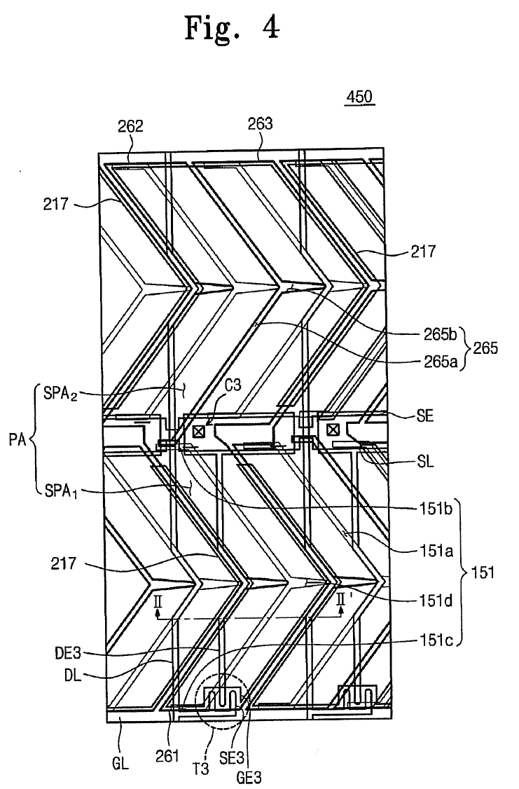

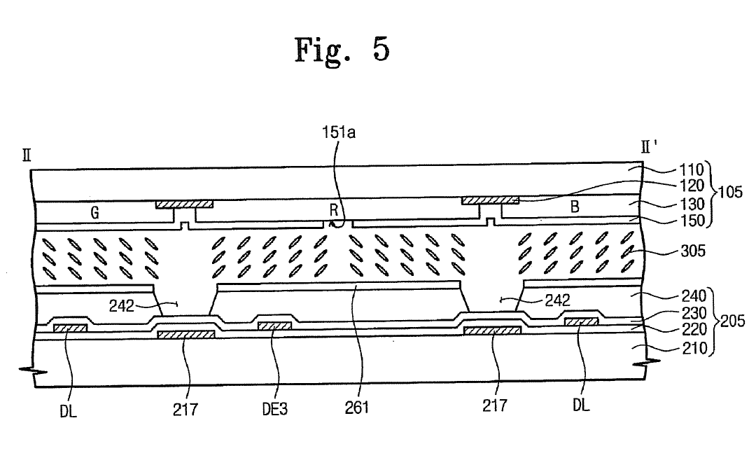

FIG. 4 is a plan view showing an exemplary embodiment of a patterned vertical alignment (“PVA”) mode display panel according to the present invention, and FIG. 5 is a sectional view taken along line II-II′ shown in FIG. 4.

Referring to FIGS. 4 and 5, a PVA mode display panel 450 includes a first display substrate 105, a second display substrate 205 facing the first display substrate 105, and a liquid crystal layer 305 disposed between the first display substrate 105 and the second display substrate 205.

The first display substrate 105 includes a first base substrate 110, a black matrix 120, a color filter layer 130, and a common electrode 150.

The common electrode 150 is provided with a plurality of first openings 151 formed therethrough to expose the color filter layer 130. Each of the first openings 151 includes a first V-shaped opening 151a, a first I-shaped opening 151b, a second I-shaped opening 151c and a third I-shaped opening 151d. The first and second I-shaped openings 151b and 151c are extended from both ends of the first V-shaped opening 151a, respectively, and the third I-shaped opening 151d is extended from a bending portion of the first V-shaped opening 151a.

Meanwhile, the second display substrate 205 includes a second base substrate 210, a gate line GL, a data line DL, a third TFT T3, a first pixel electrode 261, a second pixel electrode 262, a third pixel electrode 263, and a trap electrode 217.

The gate line GL and the data line DL are formed on the second base substrate 210. The gate line GL and the data line DL are extended in directions substantially perpendicular to each other to define pixel areas PA in a matrix configuration on the second base substrate 210. The gate line GL and the data line DL are electrically insulated from each other by a gate insulating layer 220. In the exemplary embodiment, each of the pixel areas PA has substantially a same design, and thus one pixel area will be described as an example.

The second display substrate 205 further includes a storage line SL and a storage electrode SE that are extended in substantially parallel to the gate line GL, and formed on a same layer as a layer on which the gate line GL is formed. In the exemplary embodiment, the storage line SL is placed at a central region of the pixel area PA. Thus, the pixel area PA is divided into a first sub pixel area SPA1 and a second sub pixel area SPA2 with reference to the storage line SL. The storage electrode SE is expanded from the storage line SL to have a substantially rectangular shape.

The third TFT T3 is formed in the first sub pixel area SPA1 and electrically connected to the gate line GL and the data line DL. Particularly, the third TFT T3 includes a third gate electrode GE3 branched from the gate line GL, a third source electrode SE3 branched from the data line DL, and a third drain electrode DE3 spaced apart from the third source electrode SE3 with a predetermined distance. The third drain electrode DE3 is extended substantially parallel with the data line DL from an area spaced from where the third source electrode SE3 is formed, and expanded to a size corresponding to the storage electrode SE in an area where the storage electrode SE is formed.

As shown in FIG. 5, the third TFT T3 and the data line DL are covered by a protective layer 230 and an organic insulating layer 240 sequentially formed on the second base substrate 210. A third contact hole C3, shown in FIG. 4, is formed through the protective layer 230 and the organic insulating layer 240 to expose the third drain electrode DE3. Also, the organic insulating layer 240 provides an opening 242 a corresponding to the trap electrode 217.

The first to third pixel electrodes 261, 262 and 263 are formed on the organic insulating layer 240. The first pixel electrode 261 may have a V shape rotated in a counter-clockwise direction and formed in the first sub pixel area SPA1. The second and third pixel electrodes 262 and 263 may also have a V shape rotated in the counter-clockwise direction, but are formed in the second sub pixel area SPA2. The second pixel electrode 262 may have substantially a same size and a same shape as the third pixel electrode 263, and is arranged substantially parallel to the third pixel electrode 263. The second and third pixel electrodes 262 and 263 are electrically connected to the first pixel electrode 261 between the first and second sub pixel areas SPA1 and SPA2. The first pixel electrode 261 is electrically connected to the third drain electrode DE3 through the third contact hole C3, and is thus connected to the third TFT T3.

The second and third electrodes 262 and 263 are spaced apart from each other by a distance in the second sub pixel area SPA2. Thus, a second opening 265 is defined between the second pixel electrode 262 and the third pixel electrode 263 in the second sub pixel area SPA2. The second opening 265 includes a second V-shaped opening 265a and a fourth I-shaped opening 265b. The second V-shaped opening 265a is formed between longitudinal sides of the second and third pixel electrodes 262 and 263, and the fourth I-shaped opening 265b is formed at a bending portion of the second V-shaped opening 265a.

The second opening 265 is arranged relative to the first openings 151 formed through the common electrode 150 in the second sub pixel area SPA2, such that the second opening 265 is positioned in a location corresponding to a location between two adjacent first openings 151. Also, each of the first openings 151 is placed between two longitudinal sides of the first pixel electrode 261 in the first sub pixel area SPA1. Thus, each of the first and second sub pixel areas SPA1 and SPA2 may be divided into a plurality of domains where liquid crystal molecules in the liquid crystal layer 305 are aligned in different directions by the first and second openings 151 and 265.

Meanwhile, the trap electrode 217 is branched from the gate line GL and arranged between different pixel areas adjacent to the first to third pixel electrodes 261, 262 and 263 in a row direction. The trap electrode 217 may include first portions extending from the gate line GL in the first sub pixel area SPA1, and second portions extending from a previous gate line in the second sub pixel area SPA2.

As shown in FIG. 5, the black matrix 120 of the first display substrate 100 is formed in areas corresponding to between the pixel areas PA to prevent leakage of light through between the pixel areas PA. The trap electrode 217 is arranged in the BM area, an area directly beneath and overlapped by the black matrix 120.

Since the trap electrode 217 is branched from the gate line GL, the trap electrode 217 maintains a gate-off voltage during most of the period within one frame. In an exemplary embodiment, the gate-off voltage may be about −6V, a pixel voltage applied to the first to third pixel electrodes 261, 262 and 263 may be in a range of about 0V to about 10V, and a common voltage applied to the common electrode may be about 5V.

Due to such a voltage difference, a direct current field is applied between the trap electrode 217 and the first to third pixel electrodes 261, 262 and 263 and between the trap electrode 217 and the common electrode 150. Ion impurities generated in the PVA mode display panel 450 are trapped into the BM area by the direct current field, so that an image sticking caused by the ion impurities may be removed and a display quality of the PVA mode display panel 450 may be improved.

As shown in FIGS. 4 and 5, the data line DL is extended to have a stripe shape and bent at a portion to have a V shape. In the exemplary embodiment, the data line DL includes a first bent portion in the first sub pixel area SPA1 and a second bent portion in the second sub pixel area SPA2. Thus, an area in which the data line DL is formed is not precisely matched with the BM area but partially overlapped with the BM area. Therefore, the trap electrode 217 may apply the direct current field between the first to third pixel electrodes 261, 262 and 263 and the common electrode 150 without having interference from the data line DL.

Furthermore, while the trap electrode 217 and the storage line SL and storage electrode SE are formed on the same layer of the second display substrate 205 as the gate line GL, the trap electrode 217 is electrically insulated from the storage electrode SE and the storage line SL. Since the common voltage is applied to the storage electrode SE and the storage line SL, the trap electrode 217 is spaced apart from the storage electrode SE by a set distance such that the trap electrode 217 is electrically insulated from the storage electrode SE.

According to the display panel, the trap electrode is arranged in the BM area formed between the pixel electrodes, and a voltage different from the pixel voltage that is applied to the pixel electrodes (i.e., the gate-off voltage) is applied to the trap electrode.

Thus, the ion impurities in the display panel may be trapped into the BM area and the image sticking caused by the ion impurities may be removed. As a result, the display quality of the display panel may be improved.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A display panel comprising:
a first display substrate having a first base substrate and a common electrode formed on the first base substrate to receive a common voltage;
a second display substrate combined with the first display substrate while facing the first display substrate; and
a liquid crystal layer disposed between the first display substrate and the second display substrate,
the second display substrate comprising:
a second base substrate facing the first base substrate;
a plurality of gate lines formed on the second base substrate and extended in a first direction;
a plurality of data lines extended in a second direction, and insulated from and intersecting with the gate lines;
a plurality of pixel electrodes inclined at an angle with respect to the data lines; and
a trap electrode receiving a voltage different from a pixel voltage applied to the pixel electrodes to trap ion impurities, the trap electrode formed between the pixel electrodes.

2. The display panel of claim 1, wherein the trap electrode is branched from an adjacent gate line among the gate lines to receive a gate-off voltage.

3. The display panel of claim 2, wherein each of the pixel electrodes has a W shape rotated in a counter-clockwise direction, and the trap electrode is extended along longitudinal sides of the pixel electrodes.

4. The display panel of claim 2, wherein the first display substrate further comprises a black matrix having a light blocking material and formed at locations of the first display substrate corresponding to locations substantially between the pixel electrodes, and the trap electrode is formed at locations of the second display substrate corresponding to locations of the black matrix.

5. The display panel of claim 1, wherein the second display substrate further comprises:
a storage line formed on the first base substrate, extended in the first direction, substantially parallel with the gate lines, and interposed between two adjacent gate lines among the gate lines to receive the common voltage; and
a storage electrode extended from the storage line to face a corresponding pixel electrode among the pixel electrodes.

6. The display panel of claim 5, wherein the storage line and the storage electrode are formed from a same layer as the gate lines, and the trap electrode is electrically insulated from the storage electrode.

7. The display panel of claim 6, wherein the trap electrode is formed from a same layer as the gate lines, and the trap electrode is spaced from the storage electrode and the storage line.

8. The display panel of claim 1, wherein the common electrode is provided with a plurality of first openings formed therethrough, each of the pixel electrodes is provided with a second opening formed therethrough, and the second opening is disposed at a different location from locations of the first openings.

9. The display panel of claim 8, wherein the second opening is formed at a center of the pixel electrode along a longitudinal side of the pixel electrode.

10. The display panel of claim 1, wherein each of the pixel electrodes comprises:
a main pixel electrode to which a high pixel voltage is applied; and
a sub pixel electrode to which a low pixel voltage that is lower than the high pixel voltage is applied.

11. The display panel of claim 10, wherein each of the gate lines comprises:
a main gate line receiving a first gate signal during an earlier H/2 period during a 1H period in which pixels connected to one row are operated; and
a sub gate line receiving a second gate signal during a later H/2 period during the 1H period.

12. The display panel of claim 11, wherein the second display substrate further comprises:
a first thin film transistor connected to the main gate line and a corresponding data line among the data lines, the first thin film transistor outputting the high pixel voltage applied to the corresponding data line to the main pixel electrode in response to the first gate signal during the earlier H/2 period; and
a second thin film transistor connected to the sub gate line and the corresponding data line, the second thin film transistor outputting the low pixel voltage applied to the corresponding data line to the sub pixel electrode in response to the second gate signal during the later H/2 period.

13. The display panel of claim 10, wherein the main pixel electrode has a V shape rotated in a clockwise direction, the sub pixel electrode has a shape defined by subtracting the shape of the main pixel electrode from a shape of the pixel electrode, and the sub pixel electrode is electrically insulated from the main pixel electrode by an opening formed in the pixel electrode.

14. The display panel of claim 13, wherein the main pixel electrode has an area size smaller than an area size of the sub pixel electrode.

15. The display panel of claim 10, wherein the trap electrode is formed within a same layer of the second display substrate as the gate lines, and is formed within a black matrix area of the display panel.

16. The display panel of claim 10, wherein the trap electrode receives a gate-off voltage, and a direct current field is applied between the trap electrode and the pixel electrodes and between the trap electrode and the common electrode due to voltage difference between the gate-off voltage and the pixel voltage and between the gate-off voltage and the common voltage, respectively.

17. The display panel of claim 1, wherein the second display substrate further comprises an insulating layer which provides an opening corresponding to the trap electrode.

18. The display panel of claim 17, wherein the insulating layer comprises an organic insulating layer, the pixel electrodes are arranged on the organic insulating layer.

19. A method of improving display quality of a display panel, the display panel including a first display substrate having a common electrode and a second display substrate having pixel electrodes, the display panel having a black matrix area defined by a black matrix formed in the first display substrate corresponding to areas between the pixel electrodes in the second display substrate, the method comprising:
forming a trap electrode in the black matrix area; and
trapping ion impurities in the display panel into the black matrix area using the trap electrode to prevent an image sticking in the display panel.

20. The method of claim 19, wherein trapping ion impurities includes applying a direct current field between the trap electrode formed in the black matrix area and the pixel electrodes, and between the trap electrode and the common electrode.

21. The method of claim 20, further comprising forming gate lines on the first display substrate,
wherein the trap electrode is branched from the gate lines.
